(19) United States
(12) Patent Application Publication
(10) Pub. No.: US 2013/0120664 A1
(43) Pub. Date: May 16, 2013

(54) APPARATUS FOR AIRCRAFT DUAL CHANNEL DISPLAY

(71) Applicants: Mark Anthony Bushell, Cheltenham (GB); Brett Allen Eddy, Phoenix, AZ (US)

(72) Inventors: Mark Anthony Bushell, Cheltenham (GB); Brett Allen Eddy, Phoenix, AZ (US)

(73) Assignee: GE AVIATION SYSTEMS LIMITED, Cheltenham (GB)

(21) Appl. No.: 13/362,719

(22) Filed: Jan. 31, 2012

(30) Foreign Application Priority Data
Nov. 11, 2011 (GB) 11194826

(51) Int. Cl. H04N 5/50

(52) U.S. Cl. 348/731; 348/E05.097

(57) ABSTRACT

An aircraft cockpit display includes among other things an LCD panel having a liquid crystal matrix, and an LED backlight having an array of LEDs for illuminating the liquid crystal matrix. The remainder of the display allows for single point failures within the architecture without impacting the primary display functions of the LCD panel.

### CROSS-REFERENCE TO RELATED APPLICATIONS

This application claims priority under 35 U.S.C. §119 to British Patent Application No. 11194826, filed Nov. 11, 2011, the disclosure of which is incorporated herein by reference.

### BACKGROUND OF THE INVENTION

Contemporary aircraft cockpits include a flight deck having multiple flight displays, which display to the flight crew a wide range of aircraft, flight, navigation, and other information used in the operation and control of the aircraft. Within the aviation industry there is a trend towards using large widescreen format displays within the cockpit. This brings the advantage of providing a larger configurable display surface to provide more information to the flight crew and offers the ability to tailor display formats and information displayed. Because all primary flight information may be displayed on the single display surface instead of a plurality of displays or instruments the loss of the single display surface will be far more severe than with the traditional approach.

### BRIEF DESCRIPTION OF THE INVENTION

In one embodiment, an aircraft cockpit display includes an LCD panel having a liquid crystal matrix with pixels arranged in rows and columns, an LED backlight having an array of LEDs for illuminating the liquid crystal matrix, first and second independent video channels, with each video channel having a row driver operably coupled to and driving the rows in the liquid crystal matrix, a column driver operably coupled to and driving the columns in the liquid crystal matrix, and an LED driver operably coupled to the array of LEDs to control the backlight to the liquid crystal matrix, and a switch for selecting between the first and second independent video channels to display a video signal on the LCD panel.

### BRIEF DESCRIPTION OF THE DRAWINGS

In the drawings:

FIG. 1 is a schematic view of a prior design flight display module.

FIG. 2 is a perspective view of a portion of an aircraft cockpit having multiple flight display modules according to an embodiment of the invention.

FIG. 3 is a schematic view of one of the flight display modules of the aircraft cockpit of FIG. 2.

### DESCRIPTION OF EMBODIMENTS OF THE INVENTION

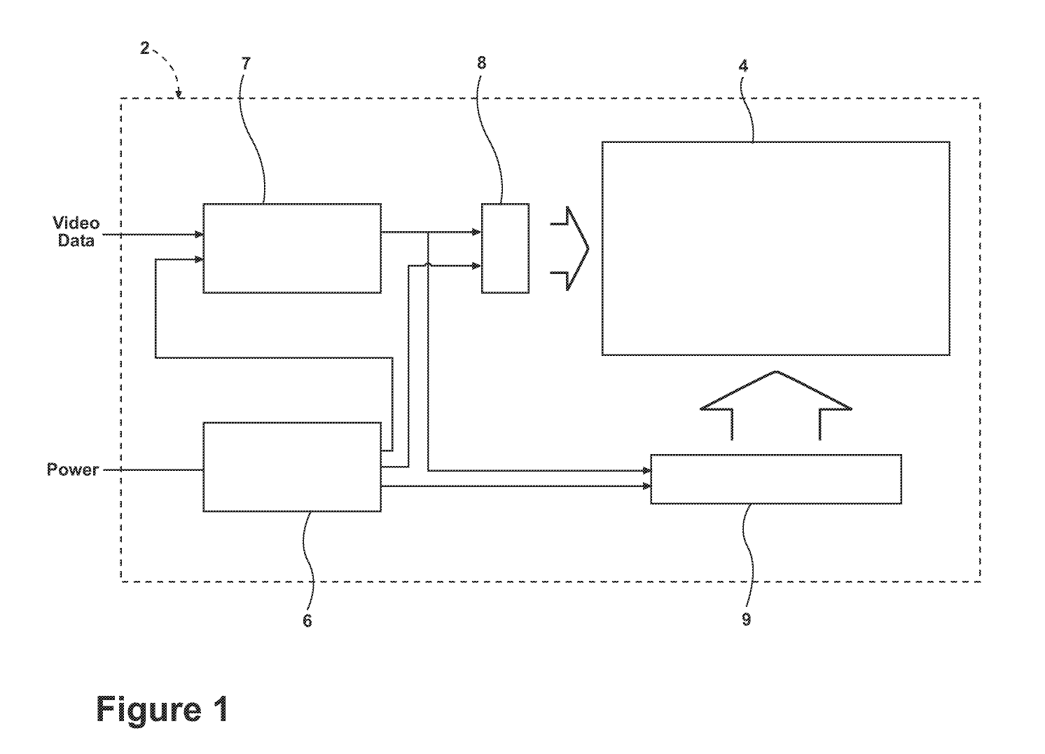

FIG. 1 illustrates a prior design flight display module 2. The flight display module 2 includes a display panel 4, which may be a widescreen LCD display panel, and associated power and control electronics including power circuitry 6, timing controls 7, display drivers in the form of row and column display drivers 8 and 9. Power and video data are fed into the flight display module 2 and any failure within the prior design flight display module 2 whether with the power circuitry 6, timing controls 7, or display drivers 8 and 9 would adversely affect the ability of the flight display module 2 to display uncorrupted video data on the display panel 4. The corruption could manifest itself as either partial or full screen video corruption on the LCD panel. When the display is a widescreen display, the effect of the loss of such a large area display is significantly more acute than the loss of a single mechanical instrument or loss of smaller electronic flight instrument displays on conventionally equipped aircrafts.

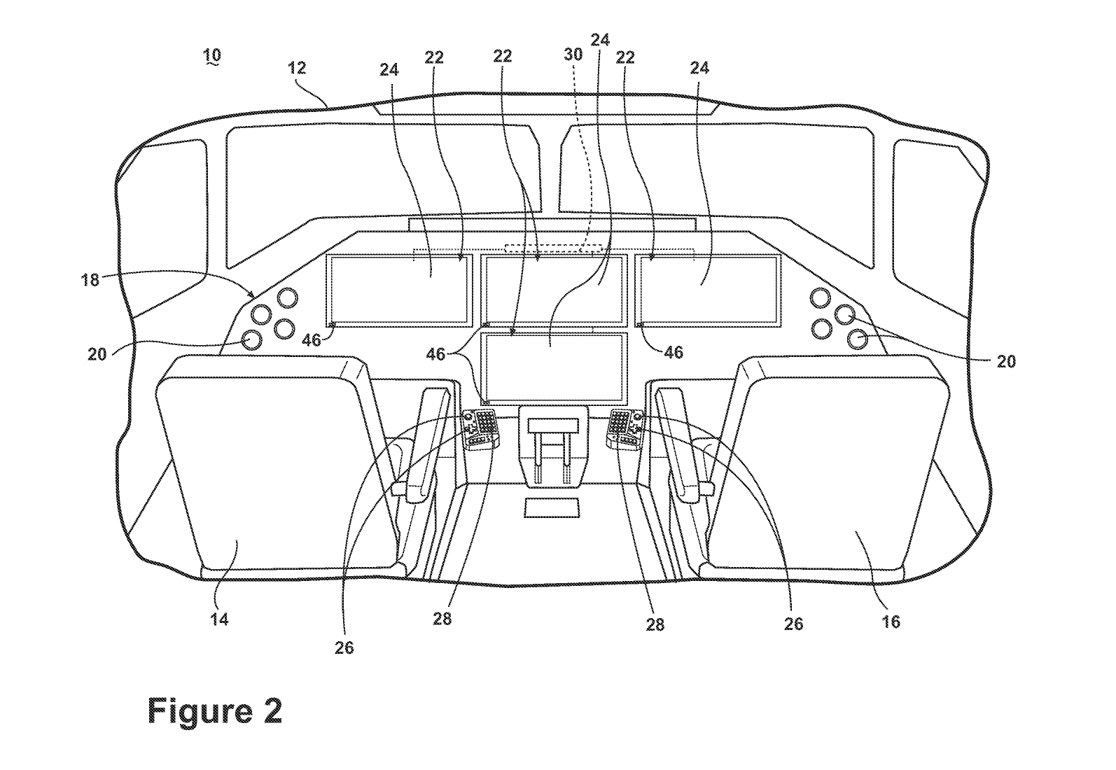

The below described inventive embodiments ensure that the flight display module has high availability and that any single failure, excluding that of the LCD panel itself, has no impact on the primary display functions. FIG. 2 illustrates a portion of an aircraft 10 having a cockpit 12 according to one embodiment of the invention. While a commercial aircraft has been illustrated, it is contemplated that embodiments of the invention may be used in any type of aircraft, for example, without limitation, fixed-wing, rotating-wing, rocket, personal aircraft, and military aircraft. A first user (e.g., a pilot) may be present in a seat 14 at the left side of the cockpit 12 and another user (e.g., a co-pilot) may be present at the right side of the cockpit 12 in a seat 16. A flight deck 18 having various instruments 20 and multiple flight display modules 22 may be located in front of the pilot and co-pilot and may provide the flight crew with information to aid in flying the aircraft 10. The flight display modules 22 may include either primary flight displays or multi-function displays and may display a wide range of aircraft, flight, navigation, systems, and other information used in the operation and control of the aircraft 10. The flight display modules 22 have been illustrated as being in a spaced, side-by-side arrangement with each other. The flight display modules 22 may be laid out in any manner including having fewer or more displays. Further, the flight display modules 22 need not be coplanar and need not be the same size. A display panel 24 on which the display representation may be provided may be included in the flight display modules 22. This display panel may include any display panel having a matrix of individually controllable pixels, such as LCD and LED. By way of non-limiting example the display panel 24 may be a flat Active Matrix Liquid Crystal Display (AMLCD) panel.

It is contemplated that one or more cursor control devices 26 and one or more multifunction keyboards 28 may be included in the cockpit 12 and may also be used by one or more flight crew members to interact with the systems of the aircraft 10. A suitable cursor control device 26 may include any device suitable to accept input from a user and to convert that input to a graphical position on any of the multiple flight display modules 22. Various joysticks, multi-way rocker switches, mice, trackballs, and the like are suitable for this purpose and each user may have separate cursor control device(s) 26 and keyboard(s) 28.

A controller 30 may be operably coupled to components of the aircraft 10 including the flight display modules 22, cursor control devices 26, and keyboards 28. The controller 30 may also be connected with other controllers (not shown) of the aircraft 10. The controller 30 may include memory and processing units, which may be running any suitable programs to operate the aircraft 10. The controller 30 may also receive inputs from one or more other additional sensors (not shown), which may provide the controller 30 with various information to aid in the operation of the aircraft 10.

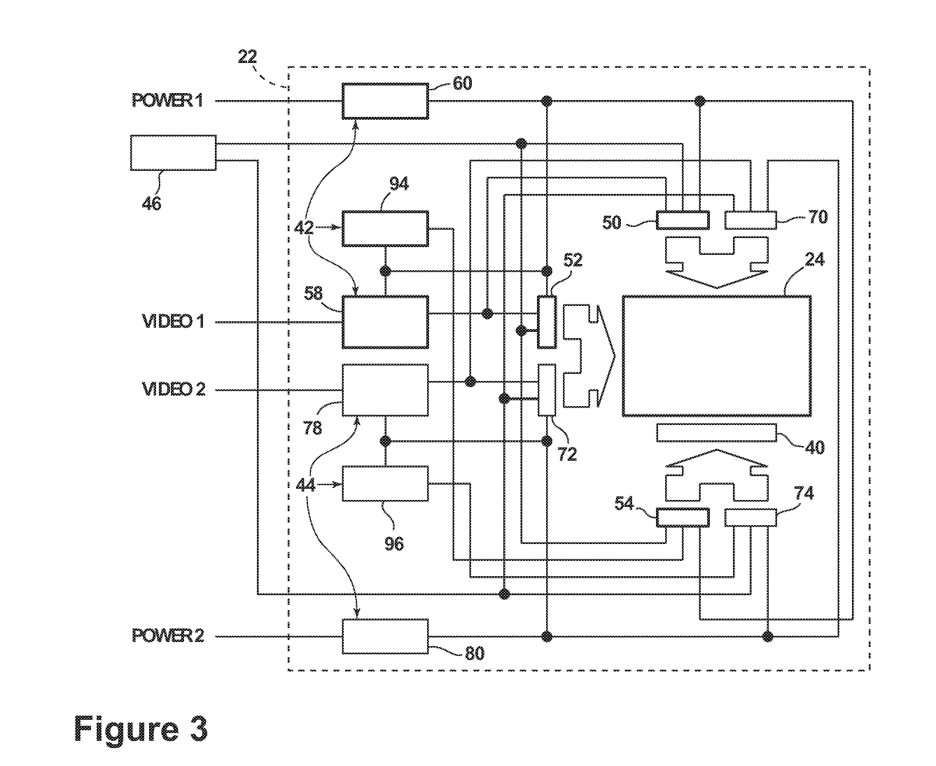

FIG. 3 illustrates a schematic embodiment of the flight display module 22. The display panel 24, a light emitting diode (LED) back light assembly 40, a first channel 42 consisting of a power source 60, timing controller 58, backlight controller 94, column driver 50, row driver 52, and LED backlight driver 54, and a second channel 44 consisting of a power source 80, timing controller 78, backlight controller 96, column driver 70, row driver 72, and LED backlight driver 74 are illustrated as being included in the flight display module 22. A switch 46 is illustrated as being operably coupled to the flight display module 22.

The display panel 24 may include a liquid crystal matrix (not shown) with an array of pixels where each pixel consists of a color group of multiple subpixels and each subpixel is addressable by rows and columns and programmed by their associated row and column drivers. Such a display panel 24 may include a horizontal dimension of 13.2 inches (335 mm), a vertical dimension of 7.9 inches (201 mm), that is, an aspect ratio of 16:9 and a diagonal dimension of 15.3 inches (389 mm) It will be appreciated that different size screens could be used and that the aspect ratio could be changed from the wide screen format mentioned above.

The LED backlight assembly 40 may be mounted behind the display panel 24 and may include an array of LEDs (not shown). Such LED arrays reproduce color better and consume less electricity then cathode fluorescent lamps. The array of LEDs in the LED backlight assembly 40 may be mounted on a printed circuit board (not shown) to give sufficient light to illuminate the liquid crystal matrix of the display panel 24.

First channel 42 and second channel 44 are two identical and independent video channels capable of displaying a video signal on the LCD panel. The first channel 42 is illustrated as including column drivers 50, row drivers 52, LED drivers 54, a timing controller 58, backlight controller 94, and a power source 60. The second channel 44 is illustrated as including column drivers 70, row drivers 72, LED drivers 74, a timing controller 78, backlight controller 96, and a power source 80.

The column drivers 50 and 70 of the first and second channels 42 and 44, respectively, are operably coupled to the columns in the liquid crystal matrix of the display panel 24. Each of the column drivers 50 and 70 are capable of selectively driving the columns in the liquid crystal matrix of the display panel 24. The row drivers 52 and 72 of the first and second channels 42 and 44, respectively, are operably coupled to the rows in the liquid crystal matrix of the display panel 24. Each of the row drivers 52 and 72 are capable of selectively driving the rows in the liquid crystal matrix of the display panel 24. The LED backlight drivers 54 and 74 are operably coupled to the array of LEDs of the LED backlight assembly 40 to control the LED backlight assembly 40 to illuminate the liquid crystal matrix of the display panel 24. Each of the LED backlight drivers 54 and 74 are capable of selectively driving the array of LEDs of the LED backlight assembly 40.

The timing controller 58 of the first channel 42 is operably coupled to the column drivers 50 and row drivers 52. The timing controller 58 is capable of outputting control signals to the column driver 50 and row driver 52. The timing controller 78 of the second channel 44 is operably coupled to the column drivers 70 and row drivers 72. The timing controller 78 is capable of outputting control signals to the column drivers 70 and row drivers 72.

The backlight controller 94 of the first channel 42 is operably coupled to the LED backlight driver 54. The backlight controller 94 is capable of outputting control signals to the LED backlight driver 54. The backlight controller 96 of the second channel 44 is operably coupled to the LED backlight driver 74. The backlight controller 96 is capable of outputting control signals to the LED backlight driver 74. It is contemplated that the timing controller and backlight controller of each of the first and second independent video channels 42 and 44 may be implemented separately or may be implemented within a single device.

A first power input or power source 60 is included in the first channel 42 and supplies power to the components of the first channel 42. A second power input or power source 80 is included in the second channel 44 and supplies power to the components of the second channel 44.

The switch 46 provides for selecting between the first and second independent video channels 42 and 44 to display a video signal from the selected first and second independent video channels 42 and 44 on the display panel 24. The switch 46 may be a manual switch that is located within reach of a pilot and/or co-pilot within the cockpit 12. The switch 46 may be integrated with the flight display module 22. For example, the switch has been illustrated as being externally mounted to the flight display module 22.

It is contemplated that the switch 46 may be a two position manual switch that selects either the first channel 42 or the second channel 44 to be the active channel. It is contemplated that the manual switch 46 could also include an auto switch position. When the auto switch position is selected, an arbiter module (not shown) within the flight display module 22 may default to a predefined channel when the flight display module 22 is powered up and may monitor the health of each function within each of the first and second independent video channels 42 and 44 that affects the integrity of the video data stream. In the event a fault is detected, the alternative channel would be automatically switched over to the active channel.

While the switch 46 has been illustrated and described as a manual switch, it is contemplated that the switch 46 may be entirely automatic. Such an automatic switch may be included within the flight display module 22. The automatic switch may be capable of switching between the first and second independent video channels 42 and 44 in response to a failure in one of the first and second independent video channels 42 and 44 and may act similarly to the auto switch position described above. Such an automatic switch mechanism or arbiter module may be duplicated within the flight display module 22.

During operation, both the first channel 42 and the second channel 44 may provide full display graphics to the display panel 24 at any time. An active channel may be initially selected automatically or manually upon powering up of the flight display module 22 and the active channel may operate the appropriate row drivers, column drivers, and LED drivers to provide a video display on the display panel 24. During normal operation, it may be possible that only one of the first channel 42 or second channel 44 is active at a time. It may also be possible for both the first channel 42 and second channel 44 to be active at the same time when both channels are operational.

A failure within the active channel may result in failure of the display panel 24, with full display functionality being restored following selection of the other channel. The selection of the other channel makes that channel the active channel and allows the appropriate row drivers, column drivers, and LED drivers to be operated to provide a video display on the display panel 24. Switching between the first channel 42 and the second channel 44 may be carried out manually, such as by the pilot or co-pilot changing the setting of the switch 46. Alternatively, the switching could be carried out by an automatic switch in response to fault detection processing built into the flight display module 22. By way of non-limiting example, there may be a display monitor that performs error detection processing to determine whether any of the graphical information, i.e., textual information, graphic symbols and charts, is erroneous.

When one channel is selected as active the inactive channel may be disabled. By way of non-limiting example, the source of power may be interrupted to the deselected channel. Alternatively or in addition to the source of power being interrupted the drivers of the deselected or inactive channel may be set to an open or tri-state condition to prevent corruption of the active channel.

The above described embodiments allow for multiple benefits. For example, the above described embodiments ensure that the flight display module has high availability and that any single failure, excluding the LCD panel itself, has no impact on the primary display functions of the flight display module. While some prior art displays are capable of having redundancy in some portions of the display, current aircraft displays do not maximize availability as described above. Due to the high availability design of the above described embodiments, full screen operation will still be possible with one graphics channel failed and integrity of the display video data is ensured in the event of a failure within the active channel. Such enhanced system availability is vital given that a failure of such a flight display would result in the total loss of primary flying instruments on one side of the cockpit. The above described embodiments restrict the number of single point failures that may cause loss of display on the flight display module. The only remaining single channel device in the flight display module is the LCD itself, but the vast majority of failures result in loss of a single pixel or a single row or column of pixels, which has minimal impact on readability of the display, rather than the total loss of the LCD. Individual LEDs of the backlight may also fail, but will have minimal impact on backlight uniformity and readability of the display. The high availability of the flight display module also allows for a reduction or elimination in maintenance delays due to electronic flight instrument system related problems associated with the display.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An aircraft cockpit display comprising:
an LCD panel having a liquid crystal matrix with pixels arranged in rows and columns;
an LED backlight having an array of LEDs for illuminating the liquid crystal matrix;
first and second independent video channels, with each video channel having a row driver operably coupled to and driving the rows in the liquid crystal matrix, a column driver operably coupled to and driving the columns in the liquid crystal matrix, and an LED driver operably coupled to the array of LEDs to control the backlight to the liquid crystal matrix; and
a switch for selecting between the first and second independent video channels to display a video signal on the LCD panel.

2. The aircraft cockpit display of claim 1 wherein the switch is an automatic switch.

3. The aircraft cockpit display of claim 2 wherein the automatic switch switches between the first and second independent video channels in response to a failure in one of the first and second independent video channels.

4. The aircraft cockpit display of claim 1 wherein the switch is a manual switch.

5. The aircraft cockpit display of claim 4 wherein the manual switch is located within reach of a pilot in the cockpit.

6. The aircraft cockpit display of claim 5 wherein the manual switch is integrated with the display.

7. The aircraft cockpit display of claim 1 wherein each of the first and second independent video channels further comprise independent sources of power.

8. The aircraft cockpit display of claim 7 wherein when a channel is deselected the source of power may be interrupted to that channel.

9. The aircraft cockpit display of claim 8 wherein when the channel is deselected the row and column drivers may be set to a tri-stated condition.

10. The aircraft cockpit display of claim 1 wherein when the channel is deselected the row and column drivers may be set to a tri stated condition.

11. The aircraft cockpit display of claim 1 wherein each of the first and second independent video channels further comprises a timing controller.

12. The aircraft cockpit display of claim 11 wherein each of the first and second independent video channels further comprises a backlight controller operably coupled to the LED driver.

13. The aircraft cockpit display of claim 12 wherein the timing controller and backlight controller of at least one of the first and second independent video channels are implemented within a single device.
